(19) United States
(12) Patent Application Publication
(10) Pub. No.: US 2006/0031418 A1
(43) Pub. Date: Feb. 9, 2006

(54) Authenticating client-to-client communication

(75) Inventor: James A. Savage, San Jose, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Mirra, Inc.

(21) Appl. No.: 11/178,022

(22) Filed: Jul. 8, 2005

Related U.S. Application Data
(60) Provisional application No. 60/592,633, filed on Jul. 30, 2004.
(60) Provisional application No. 60/592,671, filed on Jul. 30, 2004.
(60) Provisional application No. 60/592,632, filed on Jul. 30, 2004.

(51) Int. Cl. G06F 15/16

(52) U.S. Cl. 709/219

(57) ABSTRACT

A communication system may include a network, a server, and one or more clients. The server may verify that a communication among two or more of the clients should occur. The server may facilitate key agreement among the clients. The clients may authenticate using a key obtained via the key agreement. The communication may comprise content distribution, content synchronization, or another type of communication.

### CROSS-REFERENCE TO RELATED APPLICATIONS

This applications claims priority to and the benefit of U.S. Provisional Application No. 60/592,633, filed Jul. 30, 2004 and entitled AUTHENTICATING CLIENT-TO-CLIENT COMMUNICATION and U.S. Provisional Patent Application No. 60/592,671, filed Jul. 30, 2004 and entitled CONTENT DISTRIBUTION AND SYNCHRONIZATION, which are hereby incorporated by reference herein in its entirety. This application is also related to U.S. Provisional Patent Application No. 60/592,632, filed Jul. 30, 2004 entitled SERVER-ASSISTED COMMUNICATION AMONG CLIENTS, which is hereby incorporated by reference herein in its entirety.

### BACKGROUND OF THE INVENTION

1. Field of the Invention

The present invention relates generally to communication in computer systems. More specifically, the present invention relates to systems and methods for authenticating client-to-client communications in content distribution, content synchronization, and other suitable activities.

2. Related Technology

Computer and data communications networks continue to proliferate. Such networks—including wide area networks (“WANs”) and local area networks (“LANs”)—help increase productivity through sharing resources and transferring (or otherwise processing) voice and data. For example, in many systems, a file server may be connected to a network. Once connected to the network, a plurality of computers may access the file server to store and/or revise data files on the file server.

In some systems, computers may remotely access a file server, allowing a variety of persons in a variety of remote locations to collaborate on the same file. However, unreliable networks, unreliable hardware, and limited bandwidth can limit the effective collaboration in these systems. Further, because many businesses and individuals use incompatible networks, accessing the file server can often be difficult.

Accordingly, to collaborate, many persons choose to manually distribute original copies and any subsequent revisions using electronic mail (“e-mail”). Of course, this practice requires a person to diligently remember to circulate versions regularly to ensure that the other collaborators may see the latest revisions. Also, this requires a user to remember to address the e-mail to each recipient. This can be frustrating and time consuming for users that frequently share different files among different groups. Further, in some instances, attaching files to an e-mail message may result in truncated and/or corrupted files. Lastly, sending files via e-mail can waste a significant amount of storage space on an e-mail server—requiring users and/or system administrators to delete messages more often.

In some systems, computers may access a file server, allowing a person manually store a redundant copy of a data file on the file server. While helping to avoid some loss of data, this practice requires a person to diligently remember to store backups regularly to minimize data loss. Further, even with systems that backup data on scheduled intervals, the data loss between intervals can be significant.

Another problem in client-to-client communications is related to the difficulty a particular client faces when communicating with another client. It is often difficult to ensure that the other client is authentic. Also, many clients have security in place, such as a firewall, that rejects contact initiated by another client. As a result, establishing communication with another client has proven difficult.

### BRIEF SUMMARY OF EMBODIMENTS OF THE INVENTION

A need therefore exists for systems and methods that reduce some of the above-described disadvantages and problems, reduce all of the above-described disadvantages and problems, and/or reduce other disadvantages and problems.

In one embodiment, one or more appliances and/or one or more computing devices may communicate in a network. An appliance or a computing device may include a content management module configured to distribute and/or to synchronize content for backup purposes, for collaboration purposes, or for any other suitable purpose. Embodiments of the invention enable clients to verify the respective clients and facilitate key agreement such that the clients can communicate over the network.

In one embodiment, communication between appliances and/or computing devices is facilitated by a server. The server may include an authentication module configured to help establish communication among two or more clients (such as, appliances, computing devices, web browsers, and the like). For example, the authentication module may verify that a communication should occur among particular clients. The authentication module may also enable key agreement among the particular clients. The authentication module may also provide a resource identifier to some or all of the clients. The clients may establish communication using the resource identifier and may authenticate using the key that was agreed upon.

For purposes of summarizing, some aspects, advantages, and novel features have been described. Of course, it is to be understood that not necessarily all such aspects, advantages, or features will be embodied in any particular embodiment of the invention. Further, embodiments of the invention may comprise aspects, advantages, or features other than those that have been described. Some aspects, advantages, or features of embodiments of the invention may become more fully apparent from the following description and appended claims or may be learned by the practice of embodiments of the invention as set forth in this disclosure.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. Certain embodiments of the invention will be described and explained with additional specificity and detail through the use of the accompanying drawings in which:

FIG. 1A is a block diagram illustrating an exemplary embodiment of a networking system;

FIG. 1B is a block diagram illustrating an embodiment of the networking system shown in FIG. 1A;

FIG. 2A is a block diagram illustrating the use of the Hypertext Transfer Protocol;

FIG. 2B is a block diagram illustrating the use of a firewall;

FIG. 3 is a block diagram of an embodiment of the networking system shown in FIG. 1A in which two or more clients may communicate;

FIG. 4A is a flowchart illustrating an exemplary method that may be performed using the networking system shown in FIG. 3;

FIG. 4B is a flowchart illustrating an exemplary method that may be performed using the networking system shown in FIG. 3;

FIG. 4C is a flowchart illustrating an exemplary method that may be performed using the networking system shown in FIG. 3; and

FIG. 5 is a block diagram of an embodiment of the networking system shown in FIG. 3 in which two or more clients may communicate.

### DETAILED DESCRIPTION OF THE PREFERRED EMBODIMENTS

Embodiments of the invention relate to systems and methods for authenticating client-to-client communication. Client-to-client communication is often difficult because of client security. A firewall, for example, may prevent one client from initiating communication with another client. Client addresses often change as well and can prevent one client from communicating with another client. As a result, the clients are unable to communicate.

In one embodiment of the invention, communication among clients is facilitated by a server that acts as an intermediary between the clients. Through a server or through a service provided by the server, clients can exchange addresses and/or keys that enable the clients to communicate directly. Advantageously, the server has a well known address that can overcome problems associated, for example, with changing client addresses. The server can also authenticate the clients in preparation for client to client communication.

For example, the clients have established identities, which the server may be configured to authenticate. Accordingly, a client may connect to the server, and the server may authenticate the identity of the client. The client can connect to the server, for example, periodically or continuously. After the server authenticates the identity of the client, the client may request a client-to-client communication with another client.

In response to the client's request, the server may facilitate the requested communication. It will be appreciated that a server may independently determine a need for a client-to-client communication and facilitate that communication accordingly. Thus, the server may facilitate client-to-client communication among clients that connect to the server. To help facilitate the client-to-client communication, the server may provide an address or other suitable resource identifier associated with a first client to a second client, which address the second client may use to establish a direct connection between the clients. To help establish the connection, the first client may optionally open a port and/or forward a port through a gateway or other firewall. To help facilitate the client-to-client communication, the server may optionally help the clients agree on a key, which the clients may use to authenticate once the connection between the clients is established. Upon establishing the connection and authenticating, the clients may communicate in any suitable manner. The server thus may enable the clients to communicate and be authenticated.

Exemplary Networking System

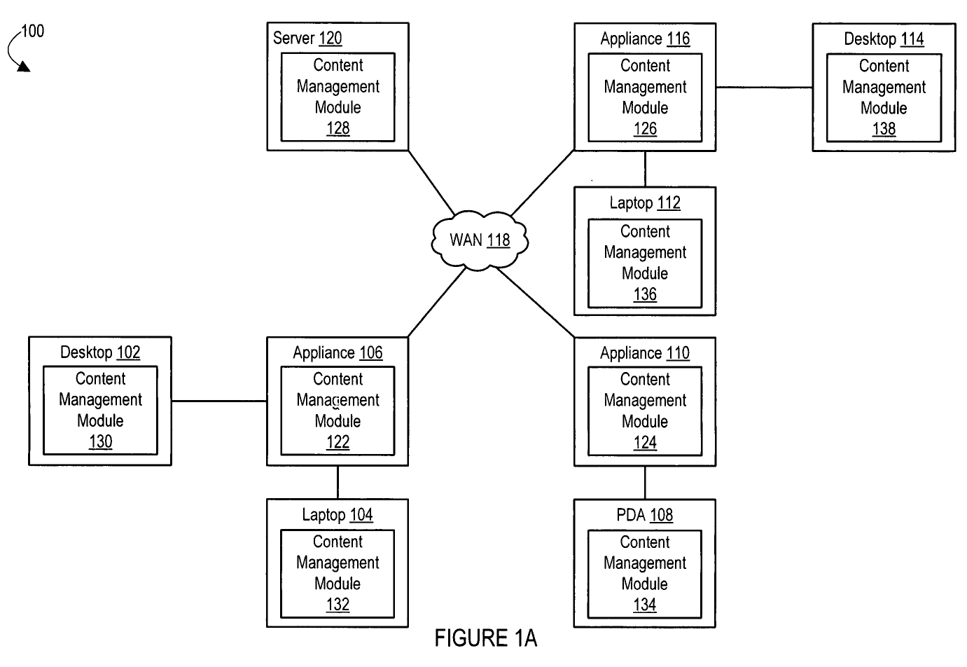

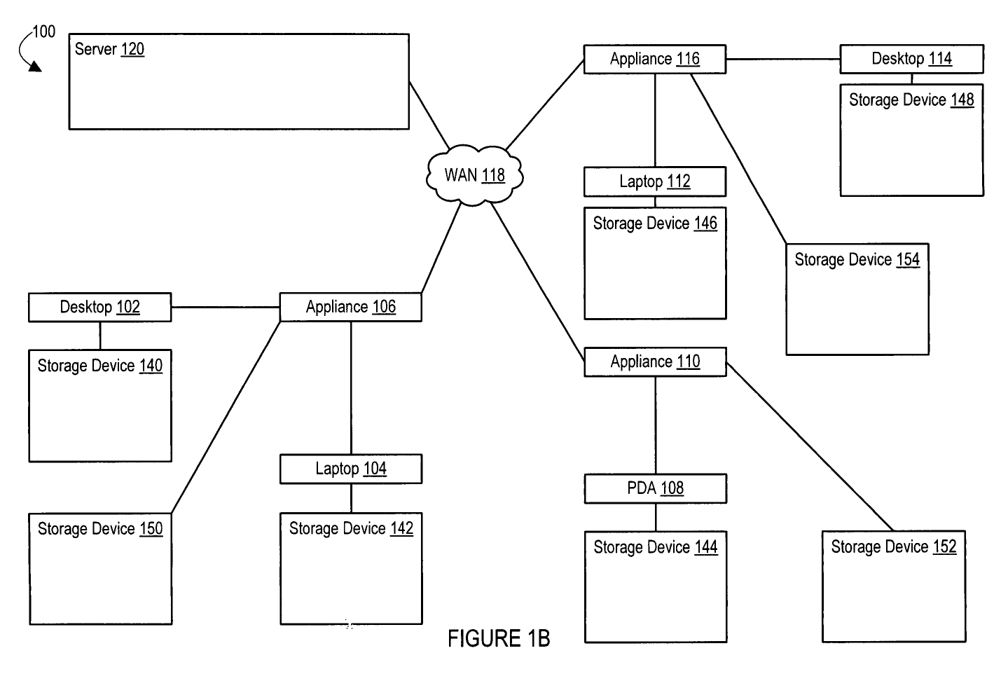

FIG. 1A is a block diagram illustrating an exemplary embodiment of a networking system 100 for implementing embodiments of the present invention. The networking system 100 may include one or more computing devices. As used herein, “computing device” is a broad term and is used in its ordinary meaning and may include, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

As shown in FIG. 1A, the networking system 100 may include one or more appliances 106, 116, and 110, which are also examples of computing devices. Each appliance 106, 110, and 116 may be associated with other computing devices. For example, a desktop computer 102 and a laptop computer 104 may be connected to the appliance 106; a PDA 108 may be connected to the appliance 110; and a laptop computer 112 and a desktop computer 114 may be connected to the appliance 116. Generally, each appliance can be associated with multiple computing devices and each computing device can be associated with multiple appliances.

As further illustrated in FIG. 1A, an appliance and any associated computing devices may be interconnected to form a network, such as a local area network. For example, the desktop computer 102, the laptop computer 104, and the appliance 106 may comprise a local area network; the PDA 108 and the appliance 110 may comprise a local area network; and the laptop computer 112, the desktop computer 114, and the appliance 116 may comprise a local area network. An appliance and any associated computing devices may be interconnected using any other suitable network including, but not limited to, a local area network, a WAN, the Internet, any other network, any other connection, or any combination thereof.

As shown in FIG. 1A, the networking environment 100 may include one or more networks, such as a network 118. The network 118 may comprise of a plurality of linked local area networks. Although illustrated as a wide-area network (WAN), the network 118 may comprise a local area network, a WAN, the Internet, any other network, any other connection, or any combination thereof. As shown in FIG. 1A, appliances, computing devices, servers, or a combination thereof may advantageously communicate via the network 118. Connections in the networking system 100 may be wireless and/or wired. As shown in FIG. 1A, the networking environment 100 may include a server 120, which may comprise one or more servers that may include one or more hardware modules, one or more software modules, or both.

The networking system 100 may include a content management system. The content management system may advantageously provide communication features, content creation features, content transfer features, content backup features, content sharing features, content distribution features, content synchronization features, any other suitable features, or any suitable combination thereof. As used herein, “content” is a broad term and is used in its ordinary meaning and includes, but is not limited to, software, documents, data, information, electronic files, any electronic materials that may be useful or desirable to backup, any electronic materials that may be useful or desirable to distribute in a network environment, any electronic materials that may be useful or desirable to synchronize in a network environment, any electronic materials that may be useful or desirable to make accessible from a remote location, any other electronic materials that may be useful or desirable to employ embodiments of the invention, and the like. The content management system may comprise a distributed system. The content management system may comprise one or more modules, which may comprise hardware components, software components, or both. The content management system may be implement using one or more computing devices, one or more appliances, one or more servers, or a combination thereof.

For example, the appliance 106 may include a content management module 122; the appliance 110 may include a content management module 124; and the appliance 116 may include a content management module 126. Similarly, a computing device, a server, or both may include module(s) related to content management as described herein. For example, the server 120 may include a content management module 128; the desktop 102 may include a content management module 130; the laptop 104 may include a content management module 132; the PDA 108 may include a content management module 134; the laptop 112 may include a content management module 136; and the desktop 114 may include a content management module 138.

FIG. 1B is a block diagram illustrating an embodiment of the networking system 100 in which appliances, computing devices, or both may include one or more associated storage devices or have access to storage devices (such as, hard drives, Random access memory, flash memory, and the like) either locally or remotely. For example, the desktop 102 may include a storage device 140; the laptop 104 may include a storage device 142; the PDA 108 may include a storage device 144; the laptop 112 may include a storage device 146; and the desktop 114 may include a storage device 148. Similarly, the appliance 106 may include a storage device 150; the appliance 110 may include a storage device 152; and the appliance 116 may include a storage device 154.

Client Requests

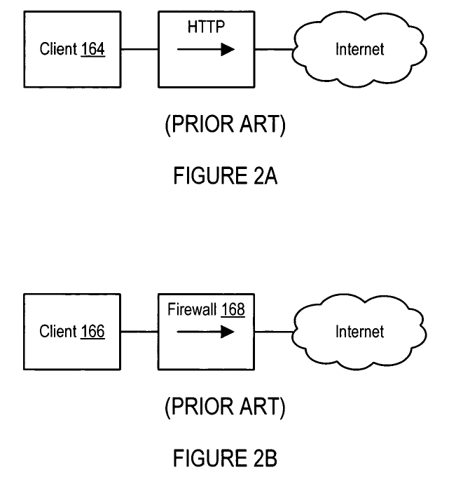

FIG. 2A is a block diagram illustrating the use of the Hypertext Transfer Protocol (HTTP). In HTTP, a client initiated protocol, a client may initiate a transaction by sending a request to a server, which may answer the request with a response. For example, as illustrated in FIG. 2A, HTTP may advantageously be used to carry requests from a client 164 (such as, a web browser) to a server (such as, a web server—not pictured) and to transport pages from the server back to the requesting client.

FIG. 2B is a block diagram illustrating the use of a firewall 168. Generally, a firewall is a security system intended to protect a network from external threats coming from another network (such as, the Internet). A firewall typically includes hardware and/or software designed to determine whether a particular message or file from an external source may pass through the firewall to a client (such as, the client 166) and/or to determine whether a client may send a particular message or file through the firewall to an external destination. Firewalls are often configured to limit the protocols through which incoming messages and/or incoming files may arrive and often configured to limit the protocols through which outgoing messages and/or outgoing files may leave.

Many firewalls are configured to deny some or all incoming requests sent via some or all types of protocols. In a typical home use, a person may have an Internet gateway (or other firewall) that allows outgoing HTTP requests from a web browser, allows incoming responses to those outgoing HTTP requests, but denies incoming HTTP requests from external sources. Accordingly, while the person's personal computer is connected to the Internet, the person may use a web browser to access websites to receive content, but need not worry about a would-be intruder requesting and receiving content from the person's personal computer.

Because many clients are configured to use client-initiated protocols and because many clients communicate through firewalls, establishing communication between clients can be often time-consuming and sometimes impossible.

Authenticating Communication Among Clients

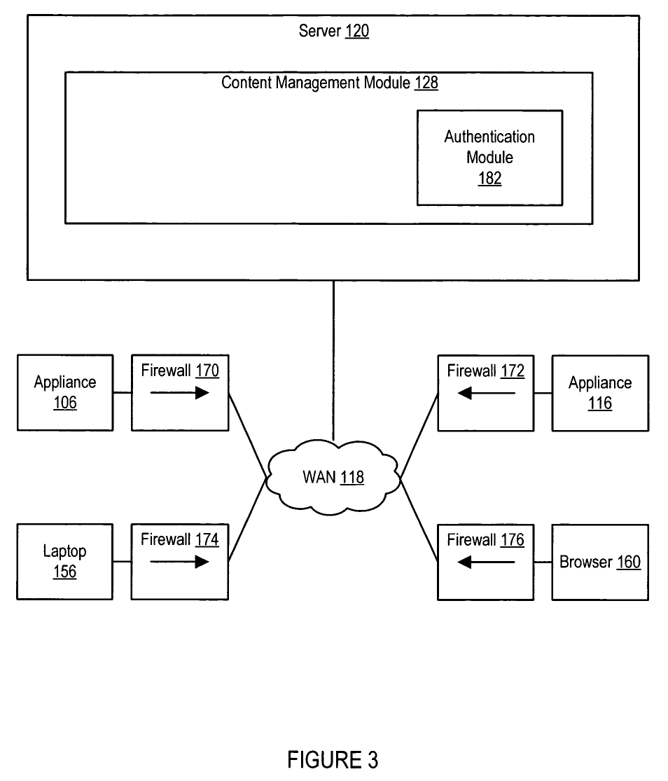

FIG. 3 is an exemplary embodiment of the networking system 100 in which two or more clients (such as, a computing device, an appliance, a content management module, a web browser, and the like) may advantageously communicate. In one embodiment, the clients may communicate through an associated firewall, gateway, or the like. For example, the appliance 106 may communicate through a firewall 170, the appliance 116 may communicate through a firewall 172, a laptop 156 may communicate through the firewall 174, and a web browser 160 may communicate through the firewall 176.

In one embodiment, the clients may communicate using HTTP, hypertext transfer protocol secure (“HTTPS”), secure sockets layer (“SSL”), a client-initiated protocol, or any other suitable protocol. In one embodiment, at least one, some, or all of the firewalls 170, 172, 174, and 176 may be configured to deny and/or allow at least one, some, or all externally-initiated transactions, requests, and the like. Also, a client need not communicate through a firewall and, thus, firewalls (such as, the firewalls 170, 172, 174, and 176) are optional.

As shown in FIG. 3, the content management module 128 of the server 120 includes an authentication module 182, which helps authenticate communication among clients. The authentication module 182 or the server 120 may also be configured to receive one or more requests from a client. Embodiments of the invention may enable clients to communicate with each other and the methods described herein can be performed, for example, a server computer, a networking environment, by a content management system, an authentication module, a client, or other modules or suitable system, or any combination thereof.

A first client, a second client, or the server 120 may have a need for the first client and the second client to communicate—such as, a need for the first client to transmit content to the second client. In one embodiment, the authentication module 182 of the server 120 may help the clients directly transmit content without the server acting as a conduit through which the content passes. Bandwidth limitations may make it impractical or impossible for a server to receive and transmit certain content, particularly when the server 120 acts as a conduit for many clients. Because the server 120 need not act as a conduit through which the content passes, many communication bottlenecks and other difficulties from bandwidth limitations may be avoided.

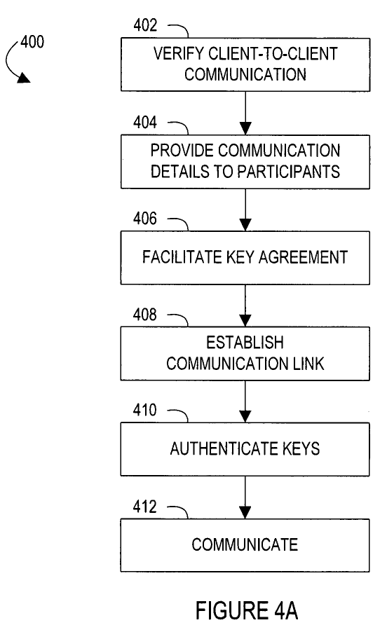

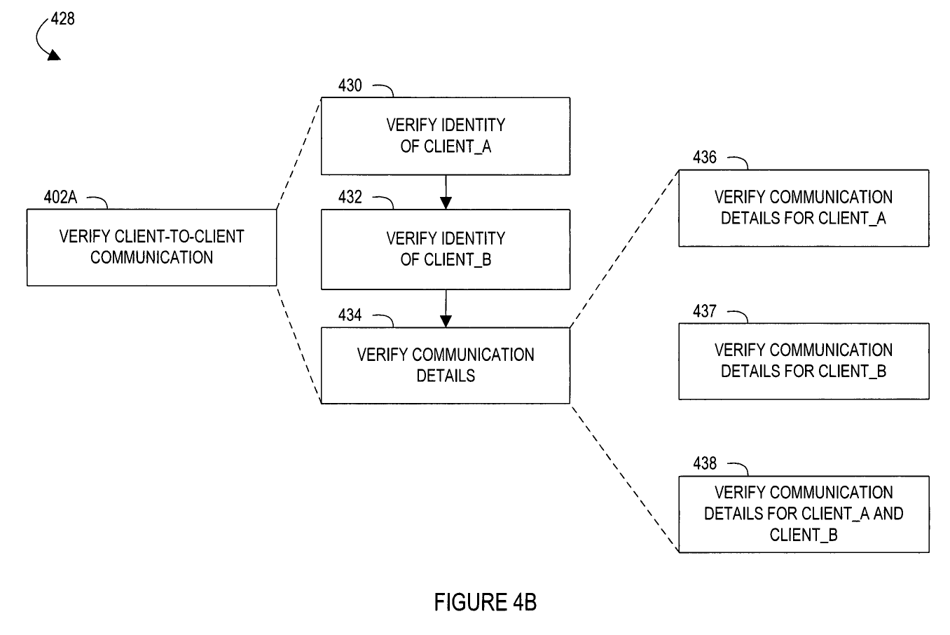

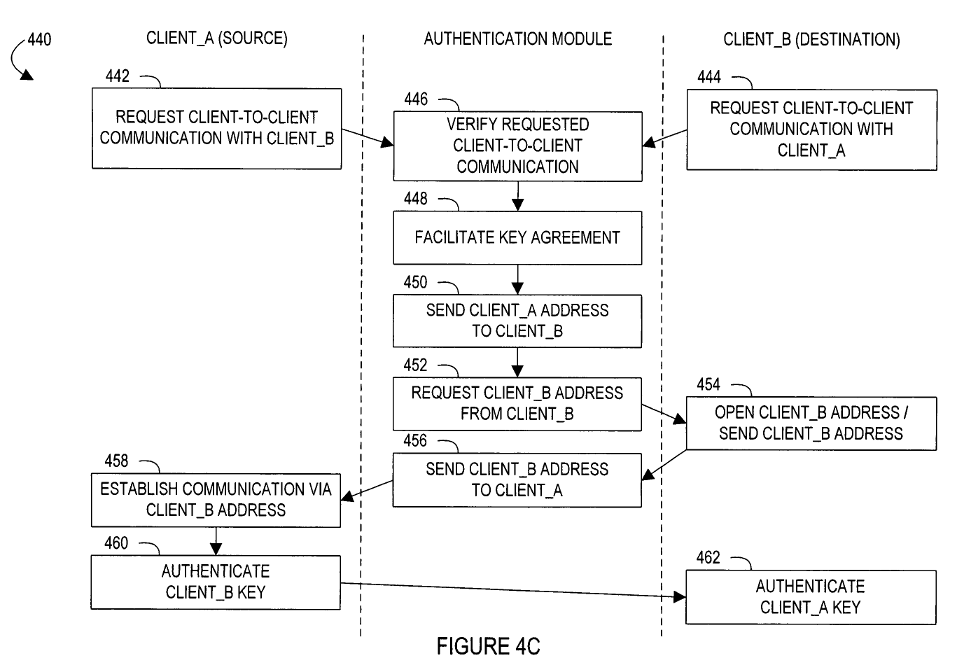

As just mentioned, a need may exist for establishing direct communication among a first client and a second client. FIG. 4A is a flowchart illustrating an exemplary method 400 for establishing such communication among clients. At a block 402, a communication among two or more clients may be verified. For example, the content management module 128 (or any suitable component thereof, such as, the authentication module 182) may verify a communication using any suitable method or system, including but not limited to those illustrated in (and described with reference to) FIG. 4B. As discussed in greater detail below with reference to FIG. 4B, verifying a communication among clients may include authenticating the identity of the clients and/or verifying that the particular communication may occur. The content management module 128 may verify a communication at the block 402 before proceeding to facilitate that communication.

At the block 404, communication details may be provided to some or all of the participants/clients in the requested communication. For example, the communications details may include one or more types of communication (such as, content distribution, content synchronization, or any other suitable type of communication), one or more authentication keys, one or more encryption keys, one or more addresses of one or more clients, one or more resource identifiers for one or more clients, one or more resource identifiers for content, one or more communication protocols and/or standards, and the like. It will be appreciated that keys (such as authentication keys or encryption keys) need not be sent to, exchanged with, or otherwise provided to the participants/clients in a requested communication. As discussed below, at the block 406, the authentication module 182 may facilitate key agreement by passing one or more messages sent from one client to another client, which messages the clients use to generate a key or to select a key.

As used herein, “resource identifier” is a broad term and includes, but is not limited to, a uniform resource locator (“URL”), a relative uniform resource locator (“relative URL” or “RELURL”), a uniform resource identifier (“URI”), a uniform resource name (“URN”), a character string used to identify a resource by location and/or type, a bit string used to identify a resource by location and/or type, data used to identify a resource by location and/or type, an address for a resource on the Internet, an address for a resource on a network, an address in memory, an Internet protocol address (“IP address”), a domain name, a relative address, a path, a relative path, and the like.

At a block 406, key agreement may be facilitated such that the two or more clients may agree on one or more keys used to authenticate communication among the two or more clients. For example, at the block 406, the authentication module 182 may facilitate key agreement by generating a key and/or providing a copy of the key to some or all of the clients. In one embodiment, the authentication module 182 of the server may facilitate key agreement by transferring information among the clients (such as, by passively forwarding messages from one client to another client), which information could be used to generate a key. For example, the clients could use the information to generate a key using any suitable key agreement protocol including, but not limited to, the Diffie-Hellman key agreement protocols.

In one embodiment, the authentication module 182 could facilitate key agreement by transferring information among the clients, which information could be used to select a key. For example, where each client included a set of keys associated with identifiers, the authentication module 182 could send a message to some or all of the clients that a key associated with a particular identifier should be used for authentication. Accordingly, if the authentication module 182 sent the clients a message that, for example, stated that the clients should use “the fourth key,” each client could select the fourth key from a set of keys and use that key for authentication purposes. Also, in a further example, a client may send a message, to the authentication module 182, that a key associated with a particular identifier should be used for authentication. The authentication module 182 may forward the message to the other client, which may use the identifier to select the key associated with the particular identifier. Of course, key agreement could be facilitated in any other suitable fashion and using any other suitable method or system.

As shown in FIG. 4A, two or more clients establish a communication link (at a block 408), authenticate keys (at a block 410), and (at a block 412) communicate, which may include distributing content, synchronizing content, or performing any other suitable type of communication for any other suitable purpose. In one embodiment, the clients may communicate via any suitable network and, if desired, may also communicate through a firewall, gateway, or the like. For example, in one embodiment, at the block 408, a first client may use an address and a port to establish a direct connection with a second client. If necessary or desired, the second client may open or forward a port in a gateway or other firewall, and the port may be opened or forwarded on demand. In one embodiment, at the block 410, some or all of the clients may authenticate one or more keys by exchanging the key using a digital signature algorithm—such as, the Secure Hash Algorithm (“SHA”), Keyed-Hash Message Authentication Code (“HMAC”), or the like.

FIG. 4B is a flowchart illustrating an exemplary method 428 for verifying client to client communication. In one embodiment, the block 402 (FIG. 4A) may comprise a block 402A (FIG. 4B) in which communication among two or more clients may be verified. As shown in FIG. 4B, the block 402A may comprise one or more blocks. At blocks 430 and 432, the identity of some or all of a set of two or more clients (such as, a client_a and a client_b) may be verified. In one embodiment, a client may provide data such as a username and password (or any other suitable identification data or key) to authenticate their identity to the server and be authenticated by the server.

As shown in FIG. 4B at the block 434, any suitable detail about the communication may be verified. The block 434 may comprise one or more blocks. In one embodiment, the content management module 128 (or any suitable component thereof, such as, the authentication module 182) may verify communication details for the client_a at a block 436, verify communication details for the client_b at a block 437, may verify communication details for the client_a and the client_b at the block 438, or any suitable combination thereof.

For example, the content management module 128 may implement one or more identity-based, content-management rules, which may define the content-related activities that are permitted for particular clients and permitted among particular clients. Accordingly, the contact management rules could define appropriate content-related activities (such as, distribution, synchronization, or the like) in which client_a may participate, in which client_b may participate, and in which client_a and client-b may participate together. The content management rules could identify one or more content-related actions to be performed in response to one or more events, in response to metadata associated with content, in response to other suitable factors, or any suitable combination thereof. At the block 434, the content management module 128 (or any suitable component thereof, such as, the authentication module 182) may verify details about the requested communication by using any request-related procedures, any permission-related procedures, or the like.

FIG. 4C is a flowchart illustrating an exemplary method 440 enabling client-to-client communication. As shown in FIG. 4C, clients may request the client-to-client communication; however, a server may request or initiate the client-to-client communication. The clients can be notified that the server is requesting the client-to-client communication when the clients check in with the server.

At a block 442 in FIG. 4C, a first client (“client_a”) may request communication with a second client (“client_b”). The requested communication may comprise distributing content, synchronizing content, or performing any other suitable type of communication for any other suitable purpose. As shown, the client_a may be a source of the content, and the client_b may be a destination for the content. However, client_a could be a destination for content, and the client_b could be a source of content. Also, either or both the client_a and the client_b may request communication with each other. For example, at a block 442, the client_a may request communication with the client_b, and the client_b may request communication with the client_a at a block 444. Further, it will be appreciated that neither client must request a communication. For example, as mentioned above, the content management module 128 of the server 120 may have a need for clients to communicate. Thus, while either the client_a or the client_b may request a communication, the server 120 may independently instruct the clients to communicate, if necessary.

In one embodiment, a client may connect to the authentication module 182 continuously, periodically, according to a specified schedule, or in any other suitable fashion. Preferably, a client will regularly connect to the authentication module 182, which may be configured to authenticate the identity of the client.

When a client connects to the authentication module, the authentication module 182 may authenticate the identity of the client and, if appropriate, may facilitate communication between the client and another client. For example, a first client may connect to the authentication module 182 of the server 120. After the authentication module 182 authenticates the first client's identity, a first client may request a client-to-client communication with a second client. When the second client connects to the authentication module 182, the authentication module 182 may authenticate the second client's identity. After the authentication module 182 authenticates the second client's identity, the authentication module 182 may facilitate communication between the first client and the second client. In another example, the content management module 128 of the server 120 may have a need for a first client and a second client to communicate. The first client and a second client may connect to the authentication module 182 of the server 120. After the authentication module 182 authenticates the first client's identity and the second client's identity, the authentication module 182 may facilitate communication between the first client and the second client.

To facilitate communication between client_a and client_b, at the block 446, the authentication module 182 of a server may optionally verify the communication that a client requested. In one embodiment, the authentication module 182 may verify that a communication may occur as previously described. In one embodiment, the content management module 128 may verify a requested communication at the block 446 before proceeding to facilitate key agreement at a block 448.

To facilitate communication between client_a and client_b, at the block 448, the authentication module 182 may facilitate key agreement among client_a and client_b as described with reference to the block 406 of FIG. 4A or in any other suitable manner. Advantageously, as described below, the client_a and the client_b may use the key to authenticate their identities.

To facilitate communication between client_a and client_b, the authentication module 182 may provide an address (or any other suitable resource identifier) associated with one client to the other client.

For example, the authentication module 182 may provide an address (or any other suitable resource identifier) associated with client_a to client_b. At a block 450, the authentication module 182 may optionally send an address (or any other suitable resource identifier) for the client_a to the client_b. In one embodiment, the authentication module 182 may obtain the address for the client_a by asking the client_a for an address (or any other suitable resource identifier) for the client_a. As discussed below, the client_b may receive a communication from client_a through a client_b address. Accordingly, when the client_b receives the communication, the client_b may advantageously use the address provided at the block 450 to help authenticate the identity of client_a. Of course, it will be appreciated that the client_b does not need to use the client_a address to authenticate the client_a.

As another example, the authentication module 182 may provide an address (or any other suitable resource identifier) associated with client_b to client_a. As discussed below, the client_a may establish communication with the client_b using the client_b address. To obtain the client_b address (or any other suitable resource identifier), at a block 452, the authentication module 182 may request that the client_b send an address (or any other suitable resource identifier) for the client_b. The client_b may receive the request and may, at a block 454, optionally open an address (or any other suitable resource identifier) for communication with the client_a, and send that address to the authentication module 182. For example, in one embodiment, a client may open an address for communication by opening a port in an associated firewall, gateway, or the like using, for example, an API method call or the like. Accordingly, the client may then receive communication via a port using, for example, on-demand port forwarding. Of course, a client could open an address for communication in any other suitable manner. Further, a client need not open an address for communication, and could, for example, provide an address (or other suitable resource identifier) that may already be opened for communication.

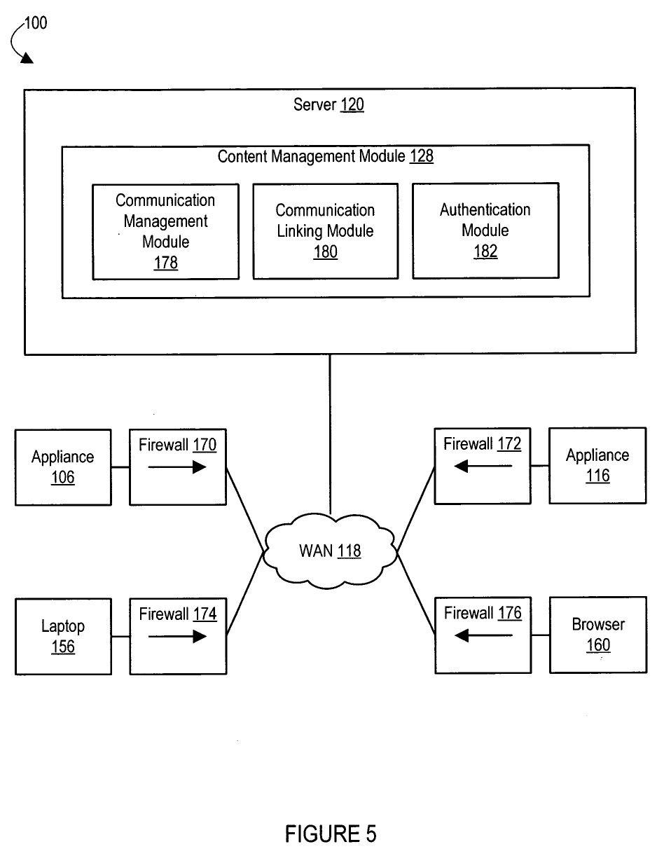

Advantageously, by opening an address or the like, a client may receive incoming communications without communicating via a linking module. Accordingly, a server may help the client to leverage the bandwidth of a network, such as the Internet, without the server having to provide the bandwidth and resources necessary to receive incoming communications, buffer the incoming communications, and transfer the incoming communications. Further, by opening an address or the like, two or more clients may use end-to-end encryption, thus, providing a more secure communication. Of course, if desired, two or more clients could still communicate using a linking module, for example, as shown in FIG. 5. Also, a client's address may change repeatedly, which makes establishing direct communication difficult. Advantageously, a server (such as, the server 120) may have a more reliable, more consistent address. Accordingly, clients may reliably connect to the authentication module 182 of the server 120 and then provide their current addresses to the authentication module 182. The authentication module 182 may, in turn, provide those current addresses to other clients to facilitate more reliable communication. In fact, this may eliminate the need for using name servers, if desired.

At a block 456, the authentication module 182 may send the client_b address (or other suitable resource identifier) to the client_a, which may use the address to establish a client-to-client connection, a peer-to-peer connection, or any other suitable communication connection with the client_b via the address at a block 458. At blocks 460 and 462, some or all of the client_a and the client_b may authenticate, in any suitable manner, the keys agreed upon at the block 448.

FIG. 5 is an exemplary embodiment of the networking system 100 (FIG. 3) in which the content management module 128 of the server 120 may optionally include the authentication module 182 and also a communication management module, a communication linking module, or both.

If desired, embodiments of the present invention may include features disclosed in the document “Mirra Manual, Release 1.1, February 2004,” which is hereby incorporated by reference herein in its entirety,—available from Mirra, Inc., 150 Mathilda Place, Suite 450, Sunnyvale, Calif. 94086.

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module—such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (FPGAs), application-specific integrated circuits (ASICs), controllers, computers, and firmware to implement those methods described above. The functionality provided for in the software, hardware, or both may be combined into fewer components or further separated into additional components. Additionally, the components may advantageously be implemented to execute on one or more computing devices.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The methods and systems described above require no particular component or function. Thus, any described component or function—despite its advantages—is optional. Also, some or all of the described components and functions may be used in connection with any number of other suitable components and functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a network that includes one or more clients, a method for establishing client-to-client communication, the method comprising:
receiving a request from a first client for communication with a second client;
verifying that communication between the first client and the second client is permitted using a set of one or more rules;
generating an authentication key if the communication between the first client and the second client is permitted under the set of one or more rules;
sending, in response to the request from the first client, a first authentication key to the first client;
sending a second authentication key to the second client, wherein the first client and the second client use the first authentication key and the second authentication key to establish communication.

2. The method of claim 1, wherein the first authentication key is identical to the second authentication key.

3. The method of claim 1, further comprising sending a resource identifier to the first client, the first client using the resource identifier to establish a connection with the second client.

4. The method of claim 1, further comprising sending a resource identifier to the second client, the second client using the resource identifier to establish a connection with the first client.

5. The method of claim 1, further comprising communicating content between the first client and the second client after a connection is established between the first client and the second client.

6. The method of claim 1, wherein each of the first client and the second client is one of a web browser, a computing device and an appliance.

7. The method of claim 1, wherein generating the authentication key further comprises identifying a particular key on a list of keys known to both the first client and the second client.

8. The method of claim 1, further comprising communicating content between the first client and the second client.

9. A method for facilitating communication among a plurality of clients, the method comprising:
receiving, from a first client, a request for communication with a second client;
verifying the request for communication with the second client to ensure that the first client is able to communicate with the second client; and
facilitating key agreement among the first client and the second client such that the first client has a first key and the second client has a second key, wherein the first client and the second client establish a link and communicate over the link if the second client authenticates the first client using the first key and the first client authenticates the second client using the second key.

10. The method of claim 9, wherein facilitating key agreement among the first client and the second client further comprises sending address information to at least one of first client and the second client.

11. The method of claim 10, further comprising:
sending address information of the first client to the second client; and
sending address information of the second client to the first client.

12. The method of claim 9, further comprising linking the first client with the second client to communicate content among the first client and the second client.

13. The method of claim 9, wherein the first key and the second key are the same key.

14. The method of claim 9, wherein facilitating key agreement among the first client and the second client comprises:
sending an identifier associated with the first key and with the second key, wherein the first key and the second key are identified from among a plurality of keys using the identifier.

15. The method of claim 9, wherein facilitating key agreement among the first client and the second client comprises:
receiving, from the first client, first data adapted for generating the first key using a key agreement protocol;
sending the first data to the second client;
receiving, from the second client, second data adapted for generating the second key using the key agreement protocol; and
sending the second data to the first client.

16. A computer readable medium having computer executable instructions for performing the method of claim 9.

17. A method for establishing communication among a plurality of computing devices, the method comprising:
sending, to a server, a request for client-to-client communication with a second client;
obtaining via the server a first key adapted for authentication;
generating first data using the first key; and
communicating the first data via a client-to-client communication connection to the second client, wherein the second client is configured to authenticate the first key using the first data.

18. The method of claim 17, wherein the first data comprises at least a portion of the first key.

19. The method of claim 17, wherein obtaining via the server a first key adapted for authentication comprises receiving the first key from the server.

20. The method of claim 17, wherein generating first data using the first key comprises applying the first key to a message using hashing algorithm.

21. The method of claim 17, further comprising:
receiving, from the server, a resource identifier for the second client; and
establishing the client-to-client communication connection using the resource identifier.

22. The method of claim 17, wherein the second client is configured to obtain via the server a second key adapted for authentication and the second client is configured to authenticate the first key using the first data and the second key and wherein the second key comprises the first key.

23. The method of claim 17, wherein the second client is configured to obtain via the server a second key adapted for authentication and the second client is configured to authenticate the first key using the first data and the second key.

24. A method for enabling a first client to establish a communication with a second client in a network, the method comprising:
receiving a request for communication among a first client and a second client, the request being received from at least one of the first client and the second client;
facilitating key agreement between the first client and the second client such that the first client and the second client agree on at least one key to be used in the communication among the first client and the second client; and
sending the at least one key to the first client and the second client, wherein the first client and the second client establish a communication link using the at least one key.

25. The method of claim 24, further comprising providing communication details to the first client and the second client, the communication details including the at least one key.

26. The method of claim 25, wherein facilitating key agreement between the first client and the second client further comprises identifying a particular key from a list of keys known to the first client and the second client.

27. The method of claim 25, further comprising communicating content between the first client and the second after the first client and the second client authenticate the at least one key.

28. A computer readable medium having computer executable instructions for performing the method of claim 25.

29. A method for a first client to establish communication in a network with a second client, the method comprising:
requesting communication with a second client from a server, wherein the server verifies the request for communication with the client;
receiving at least a key and a resource identifier from the server;
upon receiving the resource identifier, opening a port in a firewall over which the second client communicates;
establishing a communication with the second client; and
authenticating the second client using the key.

30. The method of claim 29, further comprising receiving an address of the second client from the server.

31. The method of claim 29, further comprising sending an address to the server, wherein the server sends the address to the second client.

32. A computer readable medium having computer executable instructions for performing the method of claim 29.

33. A method for facilitating communication among a plurality of clients, the method comprising:
authenticating the identity of a first client;
authenticating the identity of a second client;
providing a resource identifier associated with the second client to the first client; and
facilitating key agreement among the first client and the second client such that the first client has a first key and the second client has a second key;
wherein the first client is configured to use the resource identifier to establish a connection with the second client and wherein the second client is configured to authenticate the first key using the second key.

34. The method of claim 33, further comprising repeatedly establishing connections initiated by the first client and repeatedly establishing connections initiated by the second client.

35. The method of claim 33, further comprising receiving the resource identifier from the second client, wherein the resource identifier includes a port in a firewall and wherein the second client is configured to open the port on demand.
